(19) United States
(12) Patent Application Publication
(10) Pub. No.: US 2020/0385039 A1
(43) Pub. Date: Dec. 10, 2020

(54) Method and device to attach and detach a cargo frame to a lower frame on a cart

(71) Applicant: Jeffery Winslow, Sheridan, MT (US)

(72) Inventor: Jeffery Winslow, Sheridan, MT (US)

(21) Appl. No.: 16/501,802

(22) Filed: Jun. 7, 2019

(51) Int. Cl. B62B 1/20; B62B 5/00

(52) U.S. Cl. CPC B62B 1/202; B62B 5/0053; B62B 5/0036

(57) ABSTRACT

A method and device to easily attach and detach a cargo frame to a lower frame on a wheeled cart by inserting and securing the cargo frame into u-shaped and C-shaped brackets located on the lower frame.

### CROSS-REFERENCE TO RELATED APPLICATIONS

This application claims the benefit of PPA Ser. No. 62/763,305 filed Jun. 8, 2018 by the present inventor, which is incorporated by reference.

### FEDERALLY SPONSORED RESEARCH

This invention was not made under a government contract and the government has no rights in it.

### SEQUENCE LISTING OR PROGRAM

Not applicable.

### PRIOR ART

The following is a tabulation of some prior art that presently appears relevant:

| U.S. Patent Document No. | Inventor | Date |
|---|---|---|
| U.S. 2007/0079998 A1 | Walter | 2007 Apr. 12 |
| U.S. Pat. No. 4,589,508 A | Hoover et al. | 1986 May 20 |
| U.S. Pat. No. 4,758,010 A | Christie | 1988 Jul. 19 |
| U.S. Pat. No. 5,489,000 A | Hillbohm | 1996 Feb. 6 |
| U.S. Pat. No. 5,878,827 A | Fox | 1999 Mar. 9 |
| U.S. Pat. No. 6,065,555 A | Yuki et al. | 2000 May 23 |
| U.S. Pat. No. 6,173,799 B1 | Miyazaki et al. | 2001 Jan. 16 |
| U.S. Pat. No. 8,235,153 B1 | Robinson et al. | 2012 Aug. 7 |

| Foreign Patent Document No. | Country | Date |
|---|---|---|
| KR 2013-0141012 A | Korea | 2013 Dec. 26 |

### Non-Patent Literature

“Pro-Paw Electric Wheelbarrow 300 lb Capacity,” Copyright © 2010-2019 Handtrucks2GO.

### BACKGROUND

Examples of wheeled carts, motorized or otherwise, used for outdoor activities are numerous and vary widely in terms of design, operation, and functionality. Two traits these carts all share however appear to be difficulty in transporting the cart from one location of use to another and inefficient storage of the cart when not in use. The below-described Winslow design eliminates both of these issues thereby dramatically increasing the value and functionality of the cart.

### Advantages of the Embodiment

The below-described Winslow design allows for the quick, efficient, and secure attachment and detachment of a Cargo Frame to a Lower Frame on a wheeled cart. This unique design allows for significantly easier transport of the cart to a particular location for use as well as easier and more efficient storage of the unit when not in use.

### SUMMARY, CONCLUSION, RAMIFICATIONS, AND SCOPE

While the below description contains many specificities, these should not be construed as limitations on the scope of any embodiment, but as examples of various embodiments thereof. Many other ramifications and variations are possible within the teachings of the various embodiments without departing from the scope of the device disclosed below.

Thus the scope should be determined by the appended claims and their legal equivalents, and not by the examples given.

### BRIEF DESCRIPTION OF THE DRAWINGS

FIG. 1: Side view of the cart showing the Cargo Frame and Lower Frame. (The Lower Frame being shaded in all relevant figures.)

FIG. 2: Front end view of FIG. 1.

FIG. 3: Top view of the cart showing two Longitudinal Sides and two Latitudinal Sides.

FIG. 4: Top view of net webbing that is to be attached to the Cargo Frame.

FIG. 5: Top view of removable handles.

FIG. 6: Front end view of the Lower Frame showing the “U-shaped” and “Reversed C-Shaped” brackets attached to the Longitudinal Sides of the Lower Frame and used to hold the Cargo Frame.

FIG. 7: Front end view showing one Longitudinal Side of the Cargo Frame already inserted into the reversed C-shaped brackets on one Longitudinal Side of the Lower Frame, and also showing the other Longitudinal Side of the Cargo Frame being lowered into the U-shaped brackets located on the opposite Longitudinal Side on the Lower Frame.

### DESCRIPTION OF THE PREFERRED EMBODIMENT

The preferred embodiment of the unit comprises a plurality of components. In their broadest context, such components include:
a Lower Frame which contains at least one wheel and an arrangement of U-shaped or C-shaped brackets, and may contain a motor, battery, a means of connecting the motor to the wheel; and brake;
a Cargo Frame that securely attaches to the Lower Frame and that can be detached and used separately from the Lower Frame. The Cargo Frame may also contain the hand brake control and motor throttle, and a means of connecting said controls to the brake and motor on the Lower Frame.

Such components are individually configured and correlated with respect to each other to provide an easily transported and stored device used for transporting equipment or people in areas where other wheeled devices are unable to traverse.

### GENERAL DESCRIPTION

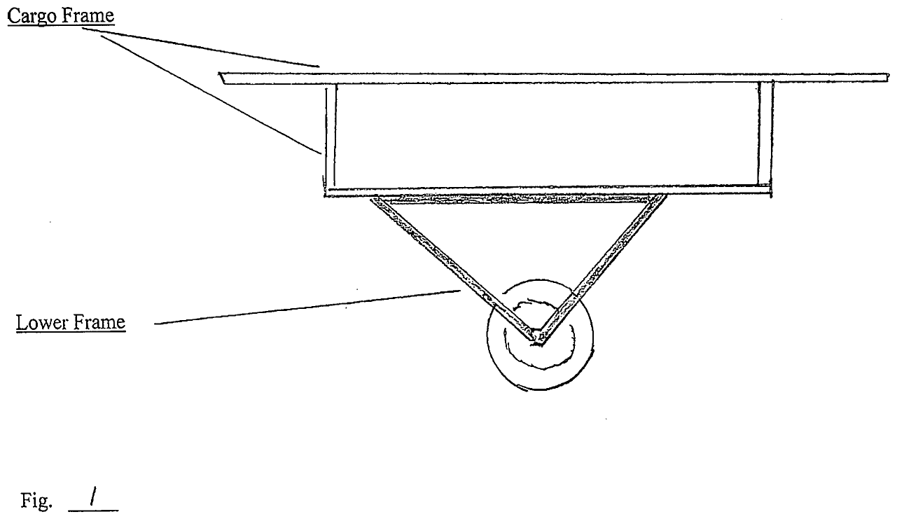

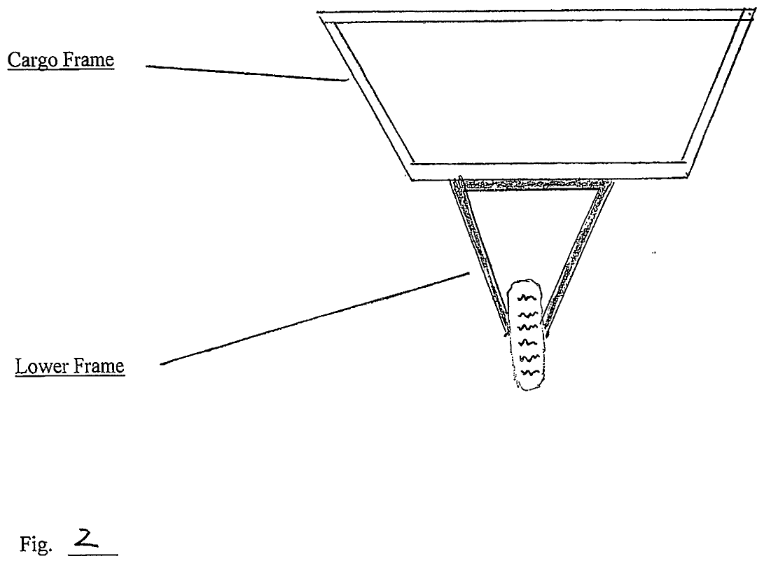

The preferred embodiment is one-wheeled cart consisting of a Lower Frame and a detachable Cargo Frame. (FIGS. 1 and 2.)

A. Lower Frame

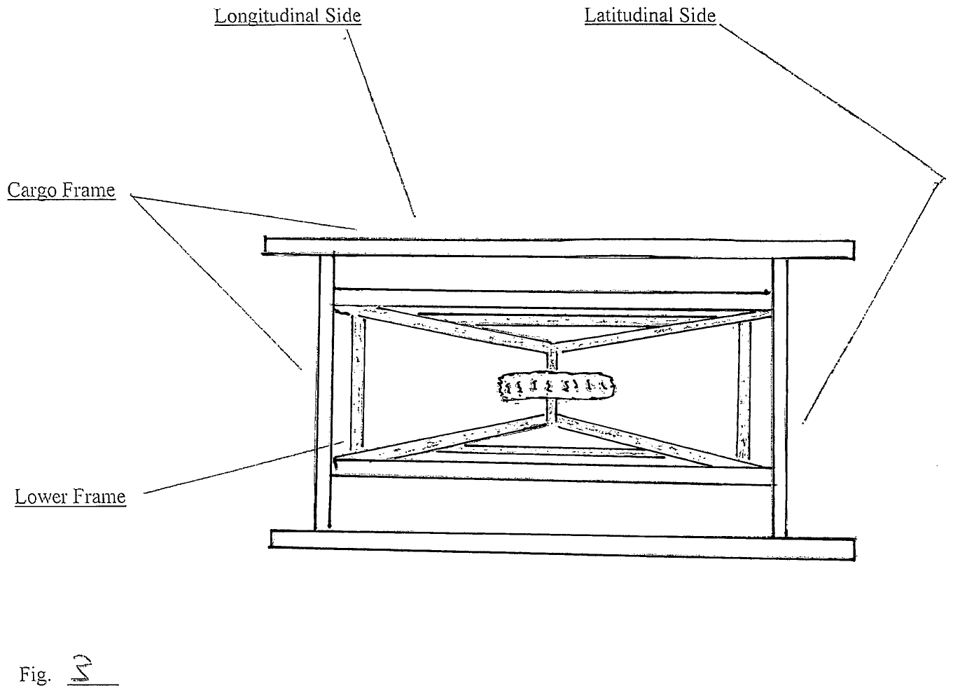

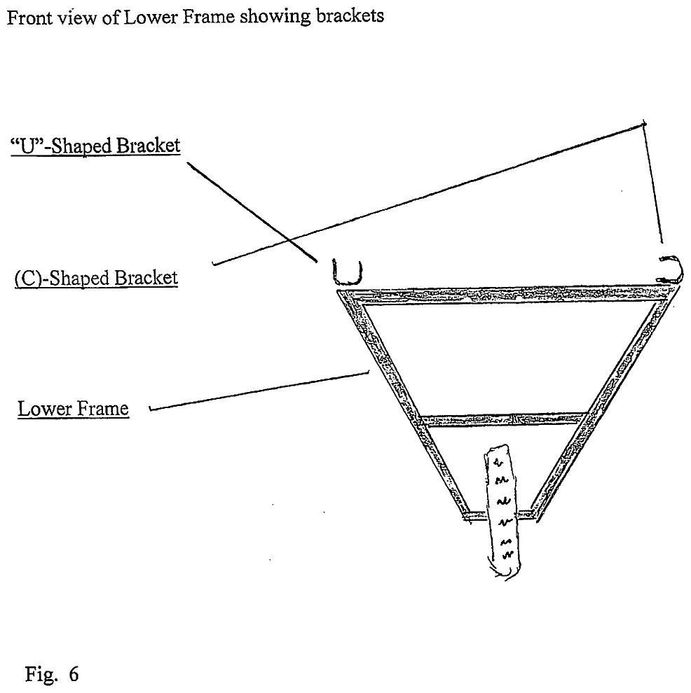

The Lower Frame can be constructed out of any suitable material and may be of any design that allows the unit to operate. However, in the preferred embodiment, the Lower Frame is comprised of metal tubes and is “V” shaped with the wheel attaching to the Lower Frame at the apex of the “V” (FIG. 1.) The top of the Lower Frame has at least four sides securely connected to each other, two of the sides directly in line with, that is, directly parallel to, the wheel and therefore directly parallel to the line of travel, hereinafter the Longitudinal Sides (FIG. 3). The top of the Lower Frame is designed to be connected to the Cargo Frame via brackets located a long each Longitudinal Side as described in Section C below. (FIG. 6)

The preferred embodiment also includes a motor of any type that allows the unit to operate but in the preferred embodiment the motor is electrical and battery operated and of such wattage to allow the unit to operate. Such battery may be of any type that will allow the unit to operate including lithium ion and the battery may be capable of solar recharge. The motor can be connected to the wheel by any means that will allow the unit to operate including chain or any other feasible connector.

In the preferred embodiment, it is anticipated that the Lower Frame will be designed to be used with various sizes of Cargo Frames for different purposes, and will be suitable to be used with different sizes of motor and batteries, again based on the particular needs of the user.

B. Cargo Frame

The Cargo Frame can be designed in any manner and made of any suitable material that allows the unit to operate. In the preferred embodiment, the Cargo Frame consists of metal tubes connected in such a manner to create an Upper and Lower Cargo Frame. (FIG. 1) The Upper Cargo Frame also has at least four sides securely connected to each other, two of the sides directly in line, that is, directly parallel, to the wheel and therefore directly parallel to the line of travel, hereinafter the Longitudinal Sides. (FIG. 3) The Longitudinal Sides are constructed of such material and designed to fit into the brackets located on the Lower Frame as described below in Section C.

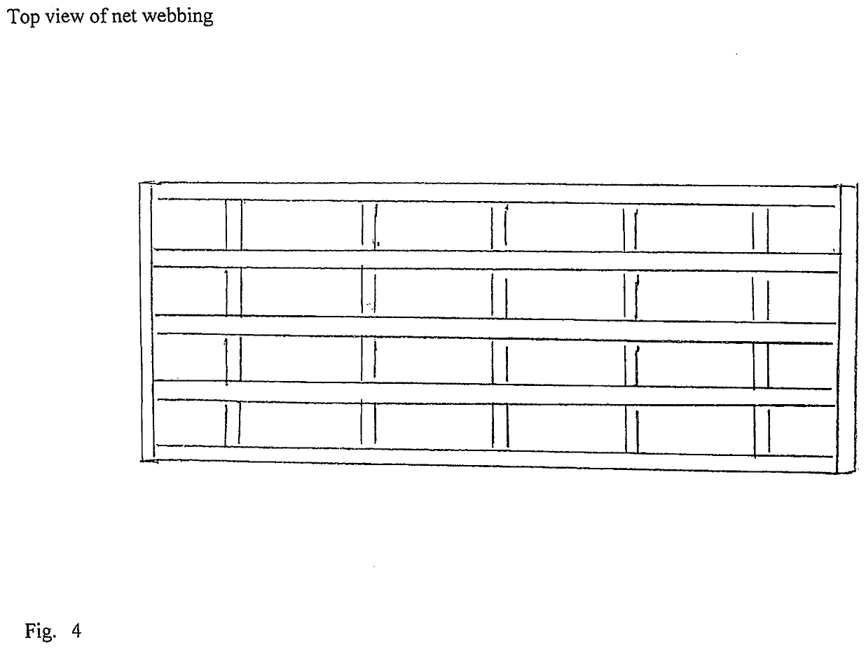

The Upper Cargo Frame is designed to hold the cargo via any means that allows the unit to operate. In the preferred embodiment, the Upper Cargo Frame is designed to have has a net, or web, attached to it. (FIG. 4)

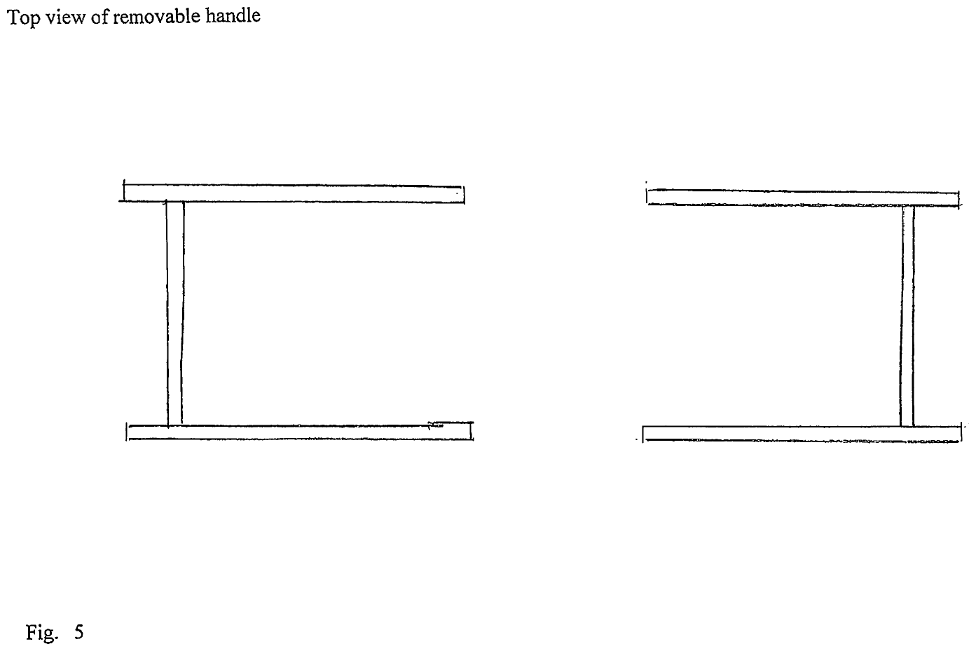

In the preferred embodiment, the Upper Cargo Frame is designed to allow for handles which can slide in and out of Upper Cargo Frame tubes. The sliding nature of handles allows for adjustable length of the unit. (FIG. 5) These handles are used to control to direction of the unit and are able to be secured to the Upper Cargo Frame, in the preferred embodiment, the handles are secured to the Upper Cargo Frame with pins that can be inserted into holes drilled through the handles and Upper Cargo Frame. The handles also contain the motor throttle and brake activation device, both mechanisms can be designed with a quick disconnect function for easy disassembly of the Lower Frame and the Cargo Frame. The Cargo Frame is designed in such a manner as to be able to overturned on to the Lower Frame and secured for travel or storage.

C. Connecting the Lower Frame to the Cargo Frame.

The most unique and innovative feature of the Winslow design is the ability to quickly attach and detach the Cargo Frame to or from the Lower Frame using a combination of U-brackets and C shaped brackets located on the Longitudinal Sides of the Lower Frame. (FIG. 6)

As shown on (FIG. 6), the Lower Frame has two U-brackets on one Longitudinal Side, in this embodiment, the U-brackets are located on the left Longitudinal Side as you're looking at the Lower Frame from the Operator's view point. There are two corresponding reversed C-Brackets on the opposing right Longitudinal Side of the Lower Frame. (FIG. 6) Although this configuration could be reversed and then the C-Brackets located left Longitudinal Side. Both the U-brackets and the reversed C-brackets are located on Lower Frame in the spot that provides the most stability, in the preferred embodiment, the brackets are located near the front and back of each side of the Lower Frame as you are looking at the Lower Frame from the front.

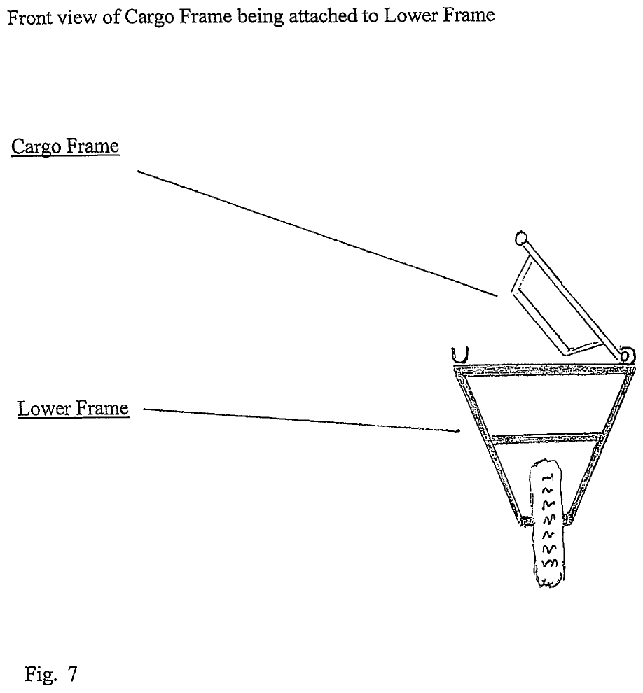

To attach the Cargo Frame to the Lower Frame, the right Longitudinal Side of the Cargo Frame, again as seen from the Operator's point of view, is inserted into the reversed C-brackets on the right Longitudinal Side of the Lower Frame and then the left Longitudinal Side of the Cargo Frame is lowered into the U-brackets on the left Longitudinal Side of the Lower Frame. (FIG. 7) The left Longitudinal Side of the Cargo Frame is then secured to the Lower Frame, in the preferred embodiment the Frame are secured via pins passing through both the U-brackets on the Lower Frame and the Cargo Frame.

To disassemble the unit the process is reversed, i.e., the cotter pins are removed and the Cargo Frame is lifted slightly from the U-brackets on the Lower Frame (FIG. 7) and both Frames are then lowered to the ground. When the Lower Frame is lying parallel to the ground, the Cargo Frame can be simply pulled out of the reversed C-brackets and away from the Lower Frame.

D. Use of the Unit

The improvements in ease of transport and storage provided by the Winslow design result in a wheeled cart with many uses, including:

Search and Rescue Teams

The unit is capable of maneuvering through narrow spaces with heavy loads well exceeding the weight of one human. The unit can negotiate steep inclines and narrow trails over rough terrain. The unit can be adapted to carry a stabilization board and to haul a variety of accessories first aid supplies such as winches and rope.

Trail Maintenance Crews/Fire Crews

The unit is capable of hauling hundreds of pounds of weight to fully equip trail maintenance crews and or fire crews for an extended period of time.

Fencing Crews

As discussed above the unit is capable of going places that other wheeled vehicles could not access with fencing supplies.

Recreation, Hunting, Game Retrieval

The unit can easily be adjusted in length and or width for ease of operation allowing a single camper to haul camping equipment or hunting equipment, and game.

Multi-Use Cargo Frame

The unit Cargo Frame, when detached from the Lower Frame, can be suspended between two trees and used as a hammock or for safe tree-suspended storage for food and other wild animal attractants.

I claim:

1) A device that allows the attachment and detachment of a Cargo Frame, to a Lower Frame (FIG. 1) on a wheeled cart, such Cargo Frame and Lower Frame each having at least four sides, two of the sides directly in line, that is, parallel, to the wheel and therefore parallel to the line of travel, hereinafter designated the Longitudinal Sides (FIG. 3), the Longitudinal Sides are constructed and designed to fit into the brackets located on the Lower Frame as described below,
a) where the Lower Frame has attached to it at least two U-shaped brackets located on one Longitudinal Side of the Lower Frame and at least two C-shaped brackets located on the opposite Longitudinal Side of the Lower Frame (FIG. 6); with the C-shaped bracket being either reversed or not depending on which specific Longitudinal Side they are located,
b) with the Longitudinal Sides of the Cargo Frame constructed and designed to fit into the brackets located on the Lower Frame
c) such arrangement allowing one Longitudinal Side of the Cargo Frame to be inserted into the C-shaped brackets located on a Longitudinal Side of the Lower Frame and then the other Longitudinal Side of the Cargo Frame is lowered into the U-shaped brackets located on the opposite Longitudinal Side of the Lower Frame; and
d) the Cargo frame is then secured to the Lower Frame.

2) A method to attach and detach a Cargo Frame, to a Lower Frame (FIG. 1) on a wheeled cart, such Cargo Frame and Lower Frame each having at least four sides, two of the sides directly in line, that is, parallel, to the wheel and therefore parallel to the line of travel, hereinafter designated the Longitudinal Sides (FIG. 3), the Longitudinal Sides are constructed and designed to fit into the brackets located on the Lower Frame as described below,
a) where the Lower Frame has attached to it at least two U-shaped brackets located on one Longitudinal Side of the Lower Frame and at least two C-shaped brackets located on the opposite Longitudinal Side of the Lower Frame (FIG. 6); with the C-shaped bracket being either reversed or not depending on which specific Longitudinal Side they are located,
b) with the Longitudinal Sides of the Cargo Frame constructed and designed to fit into the brackets located on the Lower Frame,
c) such arrangement allowing one Longitudinal Side of the Cargo Frame to be inserted into the C-shaped brackets located on a Longitudinal Side of the Lower Frame and then the other Longitudinal Side of the Cargo Frame is lowered into the U-shaped brackets located on the opposite Longitudinal Side of the Lower Frame, and
d) the Cargo frame is then secured to the Lower Frame.
